(19) United States
(12) Patent Application Publication
(10) Pub. No.: US 2026/0341127 A1
(43) Pub. Date: Oct. 29, 2026

(54) CONTENT REPRODUCTION DEVICE, VIBRATION CONTROL SIGNAL GENERATION DEVICE, SERVER DEVICE, VIBRATION CONTROL SIGNAL GENERATION METHOD, CONTENT REPRODUCTION SYSTEM, AND DESIGN ASSISTANCE DEVICE

(71) Applicant: DENSO TEN Limited, Kobe-shi, Hyogo (JP)

(72) Inventors: Rei HIROMI, Kobe-shi (JP); Yoshikuni MIKI, Kobe-shi (JP); Iku NAKAJO, Kobe-shi (JP); Akio ARAI, Kobe-shi (JP); Kazuma HASHIMOTO, Kobe-shi (JP)

(73) Assignee: DENSO TEN Limited, Kobe-shi, Hyogo (JP)

(21) Appl. No.: 19/120,627

(22) PCT Filed: Oct. 14, 2022
(86) PCT No.: PCT/JP2022/038467

§ 371 Date: Apr. 11, 2025

(51) Int. Cl. G08B 6/00; A47C 1/00; A47C 7/72; G06V 20/40; H04R 3/00

(52) U.S. Cl. CPC G08B 6/00; A47C 1/00; A47C 7/72; G06V 20/44; G06V 20/46; H04R 3/00

(57) ABSTRACT

A content reproduction device, which provides a user with a vibration according to content to be reproduced, includes a vibration output mechanism configured to generate the vibration, and a controller. The controller detects a vibration output unit of the vibration output mechanism, and controls the vibration to be generated by vibration output mechanism in accordance with the detected vibration output unit.

### TECHNICAL FIELD

The present invention relates to a content reproduction device, a vibration control signal generation device, a server device, a vibration control signal generation method, content reproduction system, and a design assistance device.

### BACKGROUND ART

Conventionally, there is proposed a technique of providing a user with a vibration according to content that is watched by the user, so as to improve presence of the content. For instance, there is known a technique of vibrating the air surrounding the user, so as to allow the user to feel air vibration by the entire body, thereby improving the presence (see, for example, Patent Document 1).

### LIST OF CITATIONS

### Patent Literature

Patent Document 1: JP-A-H11-46391

### SUMMARY OF THE INVENTION

### Technical Problem

In the content reproduction device that provides a user with a vibration so as to improve presence of content, a structure for providing (outputting) a vibration to a user (hereinafter, referred to as a vibration output mechanism) is not always the same structure. For instance, different models of chair type vibration output mechanisms have different types of vibration output units or the like to be used, different materials or shapes of chairs in which a user sits, different mounting positions of the vibration output units, or the like. For this reason, depending on the type of the vibration output mechanism, an optimal generated vibration is different, and a vibration output value or the like for vibration control that is used for generating a vibration signal is different. For this reason, it is necessary to design and adjust a dedicated content reproduction device in accordance with the vibration output mechanism that is used. Alternatively, it is necessary to design and adjust the dedicated vibration output mechanism corresponding to a vibration control signal generation device that generates a vibration control signal. Conventionally, these corresponding works are performed by man power, and hence there is a problem that huge man-hour is required.

In view of the above problem, it is an object of the present invention to provide a technique that enables efficient design and adjustment of the vibration output mechanism.

### Means for Solving the Problem

An exemplary device of the present invention is a content reproduction device that provides a user with a vibration according to content to be reproduced, and includes a vibration output mechanism configured to generate the vibration, and a controller. The controller detects a vibration output unit of the vibration output mechanism, and controls the vibration to be generated by the vibration output mechanism in accordance with the detected vibration output unit.

### Advantageous Effects of the Invention

According to the present invention, it is possible to efficiently perform selection of a vibration output unit and adjustment of a vibration control parameter value, which are related to improvement of presence of content.

### BRIEF DESCRIPTION OF DRAWINGS

FIG. 1 is an explanatory diagram illustrating an example of a content reproduction system of an embodiment.

FIG. 2 is an explanatory diagram illustrating an outline of a vibration control signal generation process performed by a content reproduction device of FIG. 1.

FIG. 3 is a structural diagram illustrating an example of the content reproduction device of FIG. 1.

FIG. 4 is a diagram illustrating an example of a scene information DB.

FIG. 5 is a diagram illustrating an example of a parameter information DB.

FIG. 6 is an explanatory diagram illustrating a layout example of vibration output units in a vibration seat of the content reproduction system.

FIG. 7 is an explanatory diagram illustrating an outline of a work of setting or the like of a vibration control parameter value and an operation of the content reproduction device performed by the content reproduction device of FIG. 3.

FIG. 8 is a flowchart illustrating a scene recognition process of currently playing content performed by a controller of the content reproduction device of FIG. 3.

FIG. 9 is a diagram illustrating an example of a scene recognition DB.

FIG. 10A is an explanatory diagram illustrating a first example of a charge (a structural vibration, an air vibration) of each vibration output unit in the content reproduction device of FIG. 6.

FIG. 10B is an explanatory diagram illustrating a second example of the charge (the structural vibration, the air vibration) of each vibration output unit in the content reproduction device of FIG. 6.

FIG. 10C is an explanatory diagram illustrating a third example of the charge (the structural vibration, the air vibration) of each vibration output unit in the content reproduction device of FIG. 6.

FIG. 11 is an explanatory diagram illustrating an example of the content reproduction system of a modified example.

FIG. 12 is a structural diagram illustrating an example of a server device of FIG. 11.

FIG. 13 is a flowchart illustrating a designing process of the vibration seat performed by a controller of the server device of FIG. 12.

### DESCRIPTION OF EMBODIMENTS

Hereinafter, an exemplary embodiment of the present invention is described in detail with reference to the drawings. Note that the present invention is not limited to details of the embodiment described below.

### <1. Outline of Vibration Control Signal Generation Method>

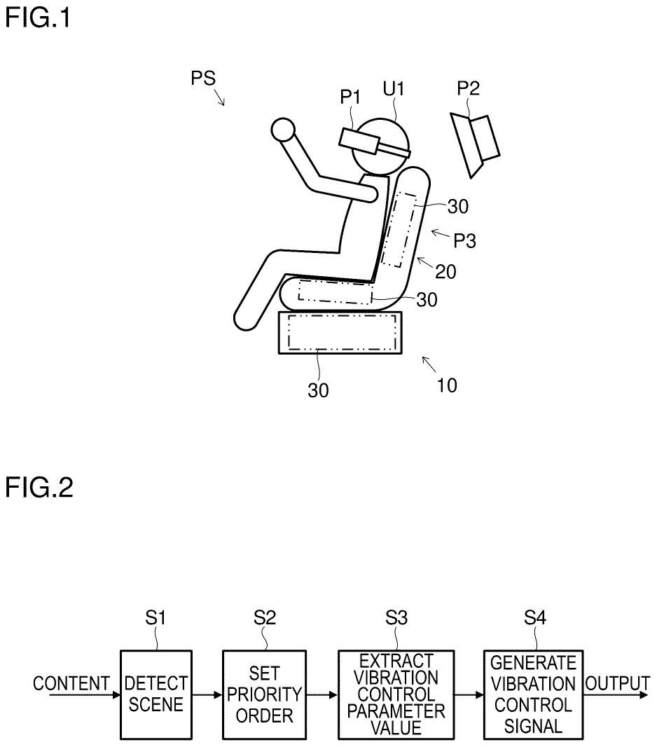

FIG. 1 is an explanatory diagram illustrating an example of a content reproduction system PS of the embodiment. As illustrated in FIG. 1, the content reproduction system PS includes a content reproduction device 10, a display device (video display unit) P1, a speaker (sound output unit) P2, and a vibration seat (vibration output mechanism) P3.

The content reproduction device 10 is a device that generates control signals of actuators for reproducing video, sound, and vibration according to content to be reproduced. The display device P1 is a device that provides a user U1 with video according to content to be reproduced (video based on a video (control) signal of the content reproduction device 10). The speaker P2 is a device that provides the user U1 with sound according to content to be reproduced (sound based on a sound (control) signal of the content reproduction device 10).

The display device P1 is a head mounted display, for example. The display device P1 outputs video according to content to be reproduced, so as to allow the user U1 to experience cross reality (XR), for example. The display device P1 includes a device such as a camera, a microphone, or a motion sensor, which detects changes of conditions inside and outside the user U1.

Note that the content provided to the user U1 is not limited to XR content, but may be a picture, a concert video, or game content, which can be displayed on a normal display. In this case, the display device P1 may be a display of a TV set or the like placed on a floor or a desk, or hung on a wall.

The speaker P2 is constituted as a headphone type, for example, and is mounted on the ears of the user U1. The speaker P2 outputs sound according to content to be reproduced, so as to provide the user U1 with the content sound. The speaker P2 is not limited to a headphone type, but may be a box type speaker, i.e., a so-called box speaker placed on a floor or a desk, or hung on a wall.

The vibration seat P3 is a chair type vibration output mechanism, for example, and includes a seat (main body of the seat (chair)) 20 in which the user U1 sits and a plurality of vibration output units 30. The vibration output units 30 are disposed inside or outside the seat 20. The vibration output unit 30 is constituted of an electric vibration converter such as an electric magnetic circuit, a piezoelectric element, or an electric cylinder, for example. The vibration output unit 30 generates a vibration according to content to be reproduced (a vibration based on a vibration (control) signal of the content reproduction device 10), and provides (outputs) the vibration to the user U1.

FIG. 2 is an explanatory diagram illustrating an outline of a vibration control signal generation process performed by the content reproduction device 10 of FIG. 1. The content reproduction device 10 first detects a scene that satisfies predetermined conditions determined in advance, from video data and sound data related to the content (Step S1).

The predetermined conditions for a scene are conditions for determining that the scene is a scene in which a vibration should be generated (a vibration should be provided to the user). Specifically, the predetermined conditions for the scene are conditions about a characteristic (weight, movement speed, or the like) of an object in the content, a distance between the object and an avatar corresponding to the user in a content space (hereinafter, referred to as an object distance), and the like. For instance, in the content space, if conditions of “the square of (object weight (Kg)/object distance (m)) is 10 or more”, and “the object is moving” are satisfied, the content reproduction device 10 determines the scene is a scene in which a vibration should be generated.

Next, the content reproduction device 10 sets a priority order of events as targets of vibration about the scene detected by the scene detection (Step S2). In other words, when it is determined that the scene is a scene in which a vibration should be generated, a plurality of the events are required to satisfy vibration generation conditions. For instance, if an elephant approaches while driving on a bad road in the content space, a vibration according to the driving on the bad road and a vibration according to the approach of the elephant are vibrations to be generated. However, if the vibrations according to both are generated, it is difficult to perceive the vibration source (which object is related to the vibration) based on human's perception characteristic of vibration. For this reason, the content reproduction device 10 regards an event for a vibration that the user should perceive more as an event having higher priority, and controls so as to generate the vibration for the event with higher priority.

Next, the content reproduction device 10 extracts a vibration control parameter value corresponding to a scene having the highest priority (a target event of vibration generation)(Step S3). The vibration control parameters are data to be used for generating a vibration, and include a low-pass filter characteristic (such as a cut-off frequency), a delay characteristic, an amplification characteristic, and the like. These parameter values are associated with a scene and are stored in a data table or the like. Note that if a vibration generation process generates vibrations according to a plurality of scenes in the order from higher priority, the same vibration generation process is performed for each of the plurality of scenes in the order from higher priority.

Next, the content reproduction device 10 generates a vibration control signal of the vibration output unit 30 of the vibration seat P3 based on the extracted vibration control parameter value (Step S4), and outputs the vibration control signal to the vibration output unit 30 of the vibration seat P3. Specifically, among information sets included in many contents, sound and vibration have relatively high correlativity. For this reason, the content reproduction device 10 processes sound data included in the content based on content data (such as the object distance, the object weight, and an object type) and the vibration control parameter value corresponding to the scene, so as to generate the vibration control signal. Further, the content reproduction device 10 outputs the generated vibration control signal to the vibration output unit 30 of the vibration seat P3. In this way, the content reproduction device 10 can provide the user with a vibration according to content to be reproduced.

### <2. Content Reproduction Device>

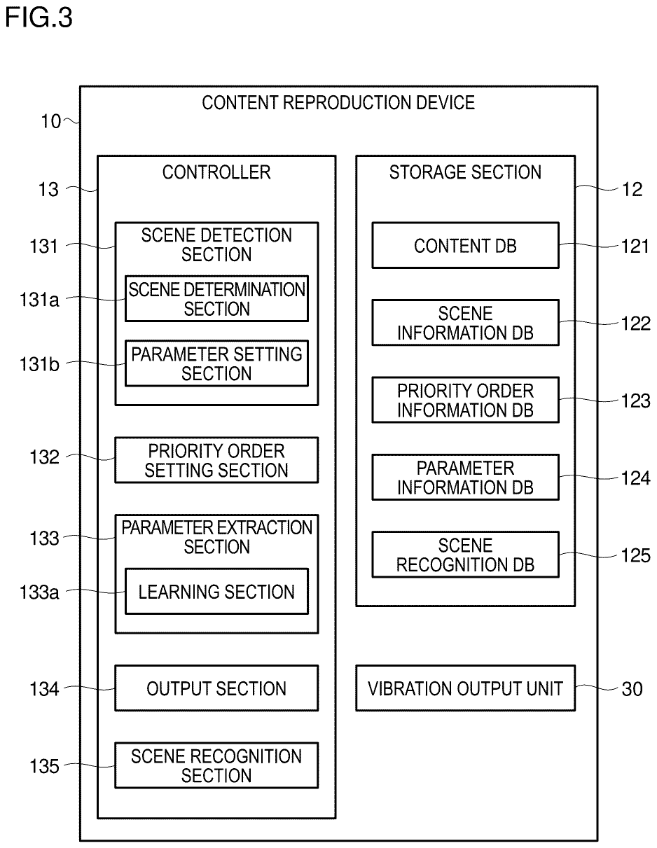

FIG. 3 is a structural diagram illustrating an example of the content reproduction device 10 of FIG. 1. In FIG. 3, structural elements necessary for describing features of this embodiment are shown, and ordinary structural elements are not shown.

As illustrated in FIG. 3, the content reproduction device 10 includes a storage section 12 and a controller 13. Note that in this description, it is supposed that the content input to the content reproduction device 10 is an “XR content”. In other words, the “user” means an operator in an XR space (a virtual character or an avatar corresponding to the user watching the content). The user watching the content (the operator) will hear sound that the virtual character (avatar) is hearing (ambient sound (such as voice sound of another character), voice sound of a virtual character). For this reason, the user in the XR content has a function of converting voice of the user and ambient sound into a sound (electric) signal (a microphone function).

The storage section 12 is configured to include a volatile memory and a nonvolatile memory. The volatile memory is constituted of a random access memory (RAM), for example. The nonvolatile memory is constituted of read only memory (ROM), a flash memory, or a hard disk drive, for example. The nonvolatile memory stores programs and data that can be read by the controller 13. It may be configured that at least a part of the programs and data stored in the nonvolatile memory is obtained from another computer device (server device) connected via wire or wireless, or a transportable recording medium.

The storage section 12 is provided with a plurality of databases (hereinafter, a database may be abbreviated as a “DB”) for various types of processing. The databases include a content DB 121, a scene information DB 122, a priority order information DB 123, a parameter information DB 124, and a scene recognition DB 125.

The content DB 121 is a database that stores data of a group of contents to be reproduced by the content reproduction device 10. Based on the data of the group of contents, video, sound, vibration, and the like of each content are reproduced. Note that the content data may be obtained from an external server (so as to regard the external server as the content DB 121), or it may be possible to use both the content DB 121 and the external server.

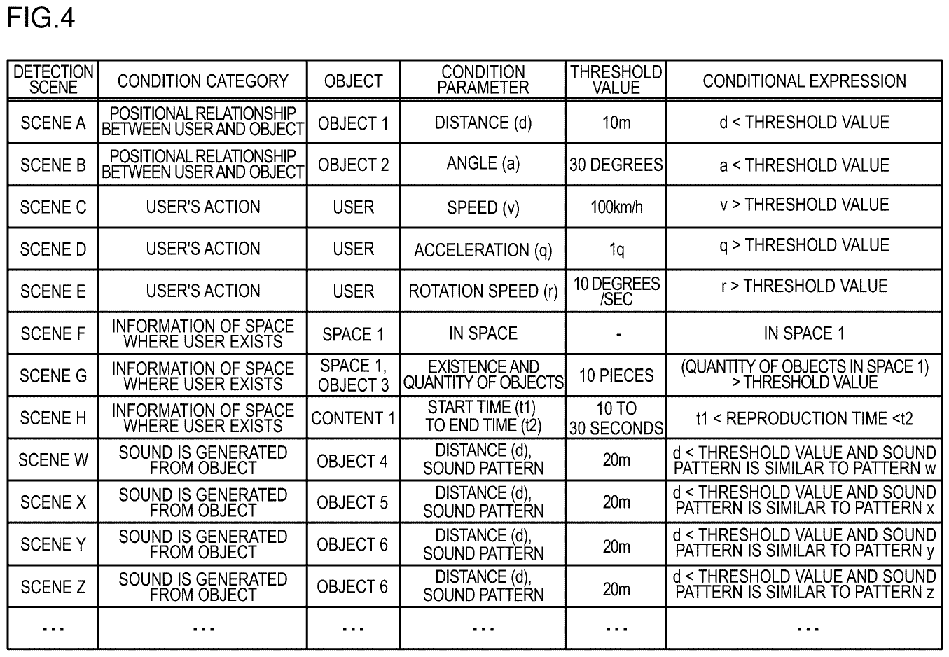

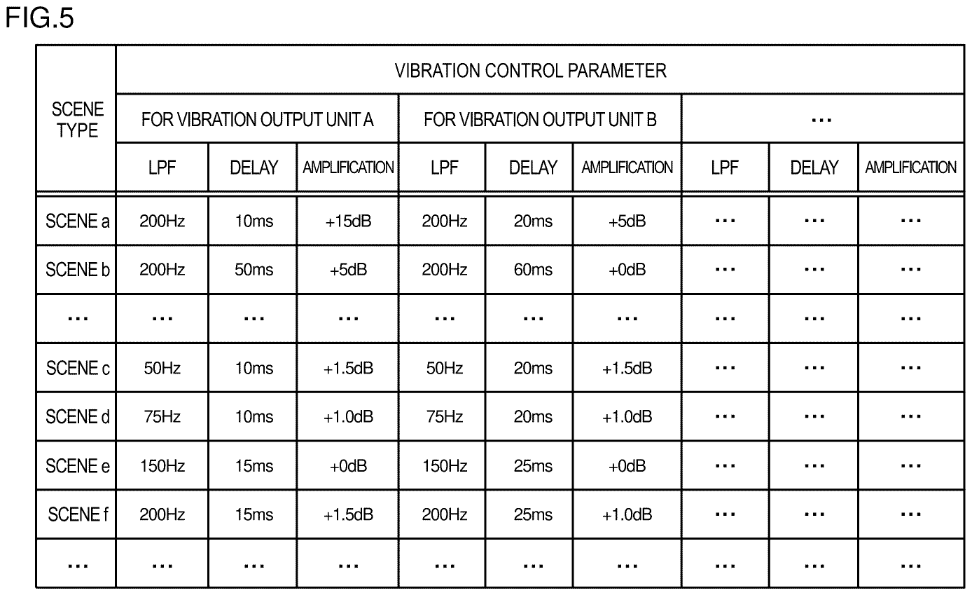

The scene information DB 122 is a database that stores various types of information about the scene as a target of vibration generation. FIG. 4 is a diagram illustrating an example of the scene information DB 122.

As illustrated in FIG. 4, the scene information DB 122 stores data of items such as “detection scene”, “condition category”, “object”, “condition parameter”, “threshold value”, and “conditional expression”. Each information is stored in association with the information of the “detection scene”.

The item “detection scene” of the scene information DB 122 is a name of a scene as identification information of the scene. The “detection scene” is also identification information for identifying a data record in the scene information DB 122. In other words, the data record of the scene information DB 122 is generated for each “detection scene” data, and data of the items “condition category”, “object”, “condition parameter”, “threshold value”, and “conditional expression” corresponding to the data record are stored. As the “detection scene”, a scene identification code such as a numeric value is usually used, but this embodiment uses a discriminable name for easy understanding of description.

The item “condition category” of the scene information DB 122 indicates a category of scene detection information, i.e., which information is used as a base for detecting the scene. In the example illustrated in FIG. 4, data of “condition category” is roughly classified into categories such as a positional relationship between the user and the object in the XR space, an action of the user, a space information in which the user exists, time information when the user exists, and a fact that sound is generated from the object.

The item “object” of the scene information DB 122 indicates a type of the object that is used for scene detection. In the example illustrated in FIG. 4, the “object” corresponds to information such as object 1, object 2, user, space 1, space 1+object 3, content 1, object 4, object 5, and object 6. Here, the object 1, the object 2, the object 3, the object 4, the object 5, and the object 6 indicate different objects in the XR space. In addition, the space 1 indicates a space in the XR space in which the user exists, for example, and the content 1 indicates the content itself.

The item “condition parameter” of the scene information DB 122 indicates a condition related to a parameter, e.g., which parameter should be used in relation to the object (data of the “object”) when performing scene detection. In the example illustrated in FIG. 4, the “condition parameter” corresponds to parameter type information such as distance, angle, speed, acceleration, rotation speed, in space, existence and quantity of objects, start time to end time, or sound pattern.

The item “threshold value” of the scene information DB 122 indicates a threshold value corresponding to a condition parameter for determining that the scene is the detection scene. The item “conditional expression” of the scene information DB 122 indicates a conditional expression for detecting that the scene is the detection scene, and for example, a relationship between the condition parameter and the threshold value is defined as the conditional expression and is stored.

Note that for convenience sake of description, in FIG. 4, each item value is expressed like “scene W”, “object 4”, or “pattern w”, using a symbol or a numeral such as “W”, “4”, or “w”, but in reality, data having a specific understandable meaning is stored as each item value.

Specifically, for example, “scene W”, “scene X”, “scene Y”, and “scene Z” of the detection scene are, in reality, data of “elephant's walking scene”, “horse's walking scene”, “car's running scene”, and “car's cornering scene”, respectively, for example. In this case, the objects, i.e., “object 4”, “object 5”, and “object 6” are, in reality, data of “elephant”, “horse”, and “car”, respectively. Further, “pattern w”, “pattern x”, “pattern y”, and “pattern z” of the conditional expression are, in reality, data of “horse's walking sound pattern”, “elephant's walking sound pattern”, “car's running sound pattern”, and “tire squeal sound pattern”, respectively, for example.

The sound pattern is expressed by a feature vector or the like having a sound feature amount as an element, for example. Further, if similarity (e.g., cosine similarity, Euclidean distance) between feature vectors respectively corresponding to two sound patterns is a threshold value or more, the two sound patterns can be determined to be similar to each other. For instance, “sound pattern is similar to pattern w” of the conditional expression means that similarity between the feature vector calculated from sound generated in the scene and the feature vector of sound corresponding to the pattern w is the threshold value or more.

In addition, in the content reproduction device 10, it may be possible to detect the scene by combining with the condition category or the condition parameter illustrated in FIG. 4. For instance, it may be possible that the condition category is the positional relationship between the user and the object, and that the condition parameter is position and angle for a scene a, i.e., the scene a satisfies the condition of the scene A and the condition of the scene B.

The priority order information DB 123 is a database that stores various types of information about the priority order of the vibration generation. The content reproduction device 10 sets the priority order of the vibration generation for each scene in which a vibration should be generated, based on a predetermined rule determined in advance. The rule related to the priority order of the vibration generation is stored in the priority order information DB 123. Although detailed description is omitted, as the priority order rule, for example, there is provided a rule such as “a scene detected first (or later) is given higher priority”, “a scene having a short duration time is given higher priority”, “a scene having a larger amplitude in a low frequency region is given higher priority”, or “a scene that ends first is given higher priority”.

The parameter information DB 124 is a database that stores information about the vibration control parameter of each scene. FIG. 5 is a diagram illustrating an example of the parameter information DB 124. As illustrated in FIG. 5, the parameter information DB 124 includes, for example, items “scene type” and “vibration control parameter”, and each information is stored in association with the information of “scene type”.

The item “scene type” of the parameter information DB 124 indicates a type of the scene. Data of “detection scene” illustrated in FIG. 4 is associated with data of “scene type” by a method determined in advance (e.g., a data table indicating a correspondence relationship). In other words, the data of the item “scene type” of the parameter information DB 124 and the data of the item “detection scene” of the scene information DB 122 are associated with each other by the method determined in advance. As a result, the data records of the scene information DB 122 and the parameter information DB 124 are associated (linked) with each other.

The item “vibration control parameter” of the parameter information DB 124 indicates the vibration control parameter set in the corresponding scene, and data (value) of each parameter is stored separately for each vibration output unit 30 of the vibration seat P3. As the “vibration control parameter”, for example, data of items such as “LPF (Low Pass Filter, a low frequency characteristic)”, “delay (delay characteristic)”, and “amplification (amplification factor)” are stored respectively. Note that in FIG. 5, the “vibration control parameter” is shown for two types of vibration output units, but the “vibration control parameter” is stored for each of the vibration output units that are separately controlled.

The data example illustrated in FIG. 5 shows parameter values of the vibration generation process based on the content sound. “LPF” indicates a cut-off frequency of the low-pass filter that extracts low frequency components from the sound. An item “delay” indicates a delay time of vibration after sound. An item “amplification” indicates an amplification factor, i.e., a degree to amplify or attenuate an original vibration generated from the sound, in the vibration control.

With reference to FIG. 3 again, description is continued. The controller 13 realizes various types of functions of the content reproduction device 10, and includes a processor that performs arithmetic processes and the like. The processor is configured to include a central processing unit (CPU), for example. The controller 13 may be constituted of a single processor or may be constituted of a plurality of processors. If it is constituted of a plurality of processors, the processors are communicably connected to each other and cooperate to perform processes.

The controller 13 includes, as its functions, a scene detection section 131, a priority order setting section 132, a parameter extraction section 133, and an output section 134. In this embodiment, functions of the controller 13 are realized when the processor performs the arithmetic processes in accordance with the programs stored in the storage section 12.

The scene detection section 131 includes a scene determination section 131a that determines whether or not the scene of the currently playing content is a scene in which the vibration control (generation) should be performed, and a parameter setting section 131b that sets the parameter value to be used for a process for the vibration generation process.

The scene determination section 131a determines whether or not the scene is a scene that satisfies the predetermined conditions determined in advance from the currently playing content. The scene determination section 131a determines whether or not the scene is a scene in which the vibration control should be performed (a vibration should be generated)(detects a scene in which the vibration control should be performed), using video data and sound data related to the content, and the conditional expression stored in the scene information DB 122, for example. Specifically, the scene determination section 131a determines whether or not the scene is a scene in which the vibration control should be performed, using the conditional expression of the scene information DB 122, based on coordinate information of the object in the XR space (vibration generation object), and information about the object type, for example. In addition, if the scene of the currently playing content is a scene in which the vibration control should be performed, the scene determination section 131a determines, based on the above information, which scene of “detection scene” stored in the scene information DB 122 is the relevant scene.

Specific examples are as follows. The scene determination section 131a detects the scene in which sound is generated from the object in the currently playing content. As to the sound generating scene, scene W, scene X, scene Y, and scene Z, whose condition category is “sound is generated from object” illustrated in FIG. 4 are candidate scenes. The scene determination section 131a calculates similarity between the feature vector obtained from the sound signal of the content and the feature vector of the predetermined sound in the candidate scene (the sound pattern of the condition parameter). Based on a determination result whether or not the similarity is a predetermined similarity threshold value or more, the scene determination section 131a determines whether or not the candidate scene satisfies the sound pattern condition. Further, based on a determination result whether or not the object distance in the currently playing content is a predetermined threshold value or less, the scene determination section 131a determines whether or not the candidate scene satisfies the object distance condition. Then, the scene determination section 131a determines the candidate scene that satisfies the sound pattern condition and the object distance condition (satisfies the conditional expression), as the detection scene in which the vibration generation should be performed.

Note that if the scene determination section 131a determines that the scene does not correspond to any detection scene, the vibration generation is not performed as there is no corresponding detection scene (the vibration control parameter is set to a value of no vibration).

The parameter setting section 131b sets (initially sets, changes) a value of “vibration control parameter” of the parameter information DB 124. As a main setting method of the parameter value, there is a setting method based on information input by a developer or a user of the XR content, and an automatic setting method based on a content type or the like.

Specifically, in the setting method of the parameter value based on information input by the user, the user selects the scene for which the parameter value is set (adjusted) and the parameter type to be set (adjusted), and sets the parameter to be set in the scene by operating an up/down operation button or the like. When the setting is performed, it is preferred to display a test image of the scene for which the parameter is set, and to generate a vibration based on the currently setting parameter, so as to set while perceiving the vibration.

In addition, in the automatic setting method of the parameter value based on the content scene type or the like, the scene type of the content to be reproduced is first detected. Detection of the content type is determined based on scene type information or the like given to the content information, or is estimated by analyzing a part of the content video and sound. Further, the automatic setting method sets each parameter value in accordance with the detected content type.

The parameter value can be obtained, for example, from a server (sending a parameter value request signal including the scene type information)(that collects the parameter information from each device, performs statistical treatment or the like on the same, and stores the appropriate parameter value for the content scene type), based on the content scene type information. In this way, setting of the parameter information DB 124 can be configured more appropriately.

In addition, it is efficient that the parameter setting section 131b sets the vibration control parameter value for the scene, in which an amplitude of sound in the low frequency region generated from the object is more than a predetermined threshold value, among content scenes, as the scene in which a vibration should be generated. The object that generates a large vibration has a large correlation with the object that generates large sound in the low frequency region, and the amplitude of the vibration also has a correlation with the amplitude of the low frequency region of the sound. Therefore, the scene, in which an amplitude of sound in the low frequency region generated from the object is more than a predetermined threshold value, can be guessed to have a large amplitude of the vibration to be generated for improving presence, and it is effective to set the vibration control parameter value for the same as the scene in which a vibration should be generated.

Note that such the scene may be set by the user or the developer of the content, or may be obtained, for example, from a server (that collects various types of content scene information, the parameter information, and the like from each device, performs statistical treatment or the like on the same, and stores the appropriate scene information and parameter information).

In addition, the sound amplitude threshold value described above may be determined based on a type (detail) of the content. Specifically, a data table of a type (detail) of the content and an intensity threshold value is created in advance, and when selecting the scene for which the condition is set, the intensity threshold value corresponding to the target content is retrieved from the data table, and the retrieved intensity threshold value is used for selecting the scene for which the condition is set.

For instance, as the content type, there is a music video for the user to mainly listen to music, an animal documentary showing animal biology, and the like. If the music video includes an elephant's walking scene, it is preferred not to generate an excessive vibration so as not to disturb the music in many cases. In contrast, in an elephant's walking scene in an animal documentary, it is preferred to generate a vibration for improving presence in many cases.

For this reason, the parameter setting section 131b sets the threshold value in the music video to be lower than that in the animal documentary. As a result, the elephant's walking scene in the music video is hardly set as the scene in which a vibration should be generated, compared with the elephant's walking scene in the animal documentary, and hence unnecessary generation of a vibration can be suppressed in the elephant's walking scene in the music video. In this way, it is possible to generate a vibration suitable for the content.

Note that the parameter values of the scene information DB 122 and the parameter information DB 124 may be updated by calculating (adjusting) a new parameter value (e.g., an adjusted value itself, or a value after adding an offset or the like), based on various types of adjustment of the vibration (such as vibration level adjustment or delay adjustment), which the user really makes during watching the content.

With reference to FIG. 3 again, description is continued. The priority order setting section 132 sets the priority order of the scene detected by the scene detection section 131. The priority order setting section 132 refers to the priority order information DB 123, for example, and selects the scene for which the process should be prioritized, if a plurality of types of scenes are simultaneously detected by the scene detection section 131. Note that if only one scene is detected by the scene detection section 131, the scene has the highest priority order.

The parameter extraction section 133 extracts the vibration control parameter value for the scene whose priority order is set by the priority order setting section 132. Specifically, the parameter extraction section 133 refers to the parameter information DB 124, and extracts from the parameter information DB 124 the vibration control parameter value corresponding to the “detection scene”, which is given the highest priority order by the priority order setting section 132. In this case, the parameter extraction section 133 extracts the vibration control parameter values corresponding to the plurality of vibration output units 30, respectively, so that the vibration output units 30 can be controlled by their dedicated vibration control parameter values. In this way, compared with a case where the vibration output units 30 are controlled by the same vibration control parameter value, the presence can be further improved.

Based on the priority order set by the priority order setting section 132, the content reproduction device 10 can estimate an object candidate having a large influence of vibration generated by the object candidate to the user, among object candidates to be a candidate of the vibration generation object, and can select the same as the vibration generation object. In this case, the threshold value for selecting as the vibration generating object is preferably changed based on the content type. In other words, depending on detail of the content, it may be preferred to abstain or emphasize reproduction of vibration by the object in the content, and it is preferred to adjust determination detail (a determination level) of the vibration generating object.

In other words, a vibration generation principle is as follows. The vibration generating object in the content (each scene of the content) is determined based on detail of the content. Further, based on the sound signal corresponding to the determined object, the vibration signal (vibration data) is generated. In this case, the sound signal corresponding to the object is sound data of the object included in the content, or sound data of the object generated from the sound data in the scene (e.g., extracted by filtering the low frequency region). In addition, the vibration signal (vibration data) is generated by extracting low frequency components of the sound signal of the object by appropriately amplifying the same.

In addition, as the method of determining the vibration generating object, a low frequency characteristic (e.g., a sound level) of voice sound of the sound generation object in the content is estimated, and the object is determined. In this case, the low frequency characteristic of the voice sound of the sound generation object is estimated, for example, based on a reference vibration intensity based on a type of the object in a virtual space, and a distance between a reference position (a user position or the like in the virtual space) and the object. In addition, in determination of the object, the sound generation object having a larger low frequency sound level of the voice sound is determined as the vibration generating object.

In this case, the parameter extraction section 133 extracts the dedicated vibration control parameter values corresponding to the vibration output units 30, respectively. In this way, compared with a case where the vibration output units 30 are controlled by the same vibration control parameter value, the presence can be further improved.

In addition, the parameter extraction section 133 includes a learning section 133a. The learning section 133a learns a relationship between the scene stored in the parameter information DB 124 and the vibration control parameter value.

The learning section 133a performs machine learning with training data that are, for example, the scene stored in the parameter information DB 124, the corresponding vibration control parameter value, a response of the user (the content watching user provided with the vibration) to the vibration control by the vibration output unit 30 based on the parameter value, so as to update the vibration control parameter value stored in the parameter information DB 124.

In this case, it may be possible to configure that the learning section 133a uses, for example, a user's evaluation of the vibration control parameter value (the vibration provided to the user)(the vibration adjust operation by the user after the vibration control, or a questionnaire result from the user), as the training data.

In this way, the learning section 133a learns (updates) the vibration control parameter value corresponding to the scene, in view of setting the vibration control parameter value that can obtain high user's evaluation, i.e., high presence in each scene.

Further, when a new scene is reproduced, the learning section 133a determines the vibration control parameter value to be set, from a result of the learning. Specifically, for example, if the watching user performs the vibration adjust operation during reproduction of a firework scene that is not registered as the vibration generation scene, the vibration control parameter value is calculated using the new scene and the adjustment detail as the training data, and data such as the vibration control parameter value based on a result of the learning is stored in the parameter information DB 124 or the like. Note that it is also possible to use the vibration control parameter value of a similar scene so as to learn (generate) the vibration control parameter value of a new scene. For instance, when a new firework scene is reproduced, it is possible to use the vibration control parameter value of a similar situation such as an explosion scene so as to perform the vibration control, and to use a result of the learning, i.e., a response of the user, so as to learn (generate) the vibration control parameter value of the firework scene.

The output section 134 generates the vibration control signal for each vibration output unit 30, using the vibration control parameter value extracted by the parameter extraction section 133, and outputs the same to each vibration output unit 30. Specifically, the output section 134 performs a bandwidth restriction process or the like suitable for vibration using the LPF on the sound data of the vibration generation scene in the currently playing content, so as to convert the same into an original vibration data. Further, the output section 134 performs on the original vibration data a vibration adjustment process based on the vibration control parameter value extracted by the parameter extraction section 133, so as to generate the vibration control signal.

Specifically, the output section 134 performs the vibration adjustment process such as a frequency characteristic addition process of low frequency emphasis or the like, delay, and amplification on the original vibration data, for example, in accordance with the vibration control parameter value. In this way, for example, the output section 134 outputs to each of the plurality of vibration output units 30 the vibration control signal (vibration control data), which is obtained by the adjustment process of the signal suitable for vibration, obtained by processing the sound signal generated from the object in the XR space of the content, in accordance with the vibration control parameter value. In this case, the output section 134 outputs the vibration control data obtained by performing respective adjustment processes for the vibration output units 30, to the corresponding vibration output units 30, respectively.

Note that as illustrated in FIG. 5, the vibration control parameter value is set for each scene, and it is also effective to perform further correction in accordance with a detailed situation in the scene (that can also be referred to as a detailed scene type). For instance, it may be possible to increase or decrease values of the vibration control parameters “LPF”, “delay”, and “amplification”, in accordance with the distance between the user and the object (detailed scene of each distance), in the scene where the vibration object (e.g., an elephant) exists in the XR space, so as to adjust a vibration characteristic.

In this way, in the scene in which a vibration should be generated when reproducing the content, the content reproduction device 10 generates an original vibration signal based on the sound data of the scene, and further performs processing on the original vibration signal in accordance with the scene type, so as to generate the vibration control signal. As a result, even in a common content in which the content data does not include dedicated data for the vibration control, it is possible to generate a vibration that is finely adapted to each scene in the content.

### <3. Setting of Vibration Control Parameter>

Next, setting of the vibration control parameter values to the plurality of vibration output units 30 constituting the vibration output mechanism (the vibration seat P3) is described.

In order to improve presence of content, the content reproduction device 10 breaks down the vibration to be provided to the user (human) into an air vibration and a structural vibration. The air vibration means a vibration that is transferred to the body through air from a vibration source. The structural vibration means a vibration that is transferred to the body by direct contact with the vibration source, or by contact with the same through a structural component or the ground.

When reproducing the content such as the XR content, in a case of a strong vibration scene accompanying movement of a user's body movement, the structural vibration is suitable as a vibration to be provided to the user. If the scene is a scene in which a vibration other than the structural vibration is provided to the user, the air vibration is suitable as the vibration. The strong vibration scene accompanying movement of a user's body movement means, for example, a scene in which a heavy object swings in the content, the entire video (camera) swings, the user's movement in the XR content exceeds a predetermined threshold value, or a situation has occurred where an object including the user or a camera in the content contacts another object. In addition, as to the user in the XR content, a grounded condition of the user (a condition where the user is standing on the ground, or a condition where the user is flying in the air) affects intensities of the structural vibration and the air vibration.

The content reproduction device 10 breaks down the vibration to be provided to the user into the air vibration and the structural vibration for each scene of the content, and allows each of the plurality of vibration output units 30 to charge the air vibration or the structural vibration. In other words, for each of the plurality of vibration output units 30, the content reproduction device 10 uses the vibration control parameter value corresponding to the air vibration for generating the vibration control signal, so as to drive the vibration output unit 30, or uses the vibration control parameter value corresponding to the structural vibration for generating the vibration control signal, so as to drive the vibration output unit 30.

In this way, it is possible to provide the user watching the content with the air vibration through the air, and the structural vibration that is transferred to the body by direct contact with the vibration object, while appropriately using them in different manners. Further, by appropriately setting a vibration form such as a position at which the air vibration and the structural vibration is generated (provided), a vibration frequency, or a vibration waveform, the vibration can be provided to the user in various forms. Thus, presence of content can be improved.

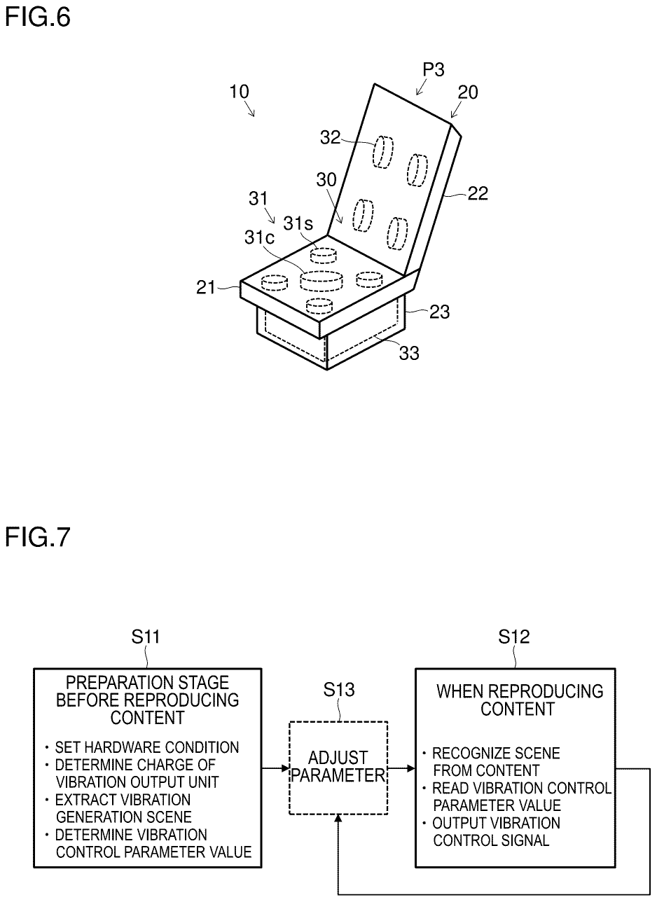

FIG. 6 is an explanatory diagram illustrating a layout example of the vibration output unit 30 of the vibration seat P3 of the content reproduction system PS. In the content reproduction system PS, inside a seating face 21 and inside a back face 22 of the seat 20, there are disposed vibration output units 31 and 32, each of which is constituted of an exciter (a vibration plate), for example. In addition, in a lower part 23 of the seat 20, there is disposed a vibration output unit 33 constituted of a six-axis electric cylinder, for example.

The vibration output units 31 of the seating face 21 of the seat 20 are arranged in five places, i.e., in four corners of the seating face 21 (vibration output units 31s) and in the center of the same (a vibration output unit 31c). Further, the vibration output unit 31c in the center of the seating face 21 has a larger vibration plate than the four other vibration output unit 31s around it, so that a vibration at a low frequency with a large amplitude can be easily generated. The vibration output units 32 of the back face 22 of the seat 20 are arranged in four places, i.e., in four corners of the back face 22. In addition, in the lower part 23 of the seat 20, there is disposed the vibration output unit 33 that generates a (low frequency and large amplitude) vibration that swings the entire seat 20. Note that a structure in which the entire seat 20 is mounted on the vibration output unit 33 can realize that the entire seat 20 is swung by the vibration generated by the vibration output unit 33.

The structural vibration is charged by the vibration output unit that is advantageous for reproducing a low frequency, and here, is charged by the vibration output unit 31c and the vibration output unit 33. In particular, a strong structural vibration accompanying a user's body movement is charged by the vibration output unit 33, which provides the user with a vibration that swings the entire body of the user. The air vibration is charged by the vibration output unit that is not pressed strongly to the user, i.e., that has low contactability with the user, and here, is charged by the vibration output unit 32, which is hardly applied with pressure of a user's weight. The vibration output units 31s in the four corners of the seating face 21 do not provide vibrations for swinging the entire body of the user, and have relatively high contactability with the user. In view of these points, here, the vibration output units 31s appropriately charges the structural vibration or the air vibration in accordance with the currently playing content and its scene.

Note that the layout and charge (the structural vibration, the air vibration) of the vibration output unit 30 according to FIG. 6 are merely an example. In accordance with a type of the vibration output unit 30, an installation location, the number of units, or the like, or a contact state between the vibration output unit 30 and the watching user, or in accordance with the content to be reproduced (particularly, in a case where only a specific content is reproduced in a dedicated gaming machine), the structural vibration or the air vibration is appropriately determined, and the vibration seat P3 is designed and assembled. Note that the contact state between the vibration output unit 30 and the watching user can be detected based on a user's operational input or a captured image of a user's watching state taken by a camera. If the contact state shows a tight contact, the vibration is suitable for the structural vibration, while if the contact state does not show a tight contact, the vibration is suitable for the air vibration.

FIG. 7 is an explanatory diagram illustrating an outline of a work of setting or the like of the vibration control parameter value performed by the content reproduction device 10 of FIG. 3, and an operation of the content reproduction device 10. These work and operation are roughly classified into a preparation stage before reproducing the content (Step S11), and a stage when reproducing the content (Step S12).

In the preparation stage before reproducing the content of Step S11, the user watching the content, or the like sets hardware conditions (a type of the vibration output unit 30, an installation location, the number of units, and the like, and the contact state between the vibration output unit 30 and the watching user). The hardware conditions (such as the installation condition of the vibration output unit 30) are input by the user watching the content, or the like, who operates an input device such as a keyboard, or by searching the database based on a type of the vibration seat P3. In addition, it is also possible to configure so that the hardware conditions are automatically input by inputting information provided from the vibration seat P3 in connection (configuration information of the vibration seat P3 is stored in a storage device, and is read to be provided when the content reproduction device 10 is connected). In addition, the contact state between the vibration output unit 30 and the watching user is detected based on a result of the operation of the input device such as the keyboard by the user watching the content, or based on a result of analyzing the captured image of the state of the user watching the content taken by the camera.

Further, based on the installation condition and information of the contact state, the controller 13 determines the charge of each vibration output unit 30, i.e., charge of the structural vibration generation, charge of the air vibration generation, or charge of both vibrations, and stores the same in the storage section 12. Note that as charge information of each vibration output unit 30, information of a correction coefficient when generating each vibration (e.g., a coefficient of 1 for the structural vibration generation, and a coefficient of 0.5 for the air vibration generation) is added, and this information is used when generating the vibration signal (e.g., a fundamental structural vibration signal is multiplied by the coefficient to make the vibration signal of the vibration output unit 30). Note that this determination is performed, for example, based on the data table that stores data indicating a relationship between the charge of each installed vibration output unit 30 and the installation condition and contact state (created by a design developer or the like of the content reproduction device 10 based on an experiment or the like).

Next, the controller 13 analyzes detail of the content so as to extract each scene of the content in which a vibration should be generated, and to detect a situation in each scene related to the vibration, for example, a grounded condition or the like of the user in the scene. Further, the controller 13 determines the vibration control parameter value of each vibration output unit 30 for each scene in which a vibration should be generated, based on the situation in the scene related to the vibration, or based on the charge information of each vibration output unit 30 determined as described above. Further, the controller 13 stores the determined parameter information for each scene and for each the vibration output unit 30 in the parameter information DB 124.

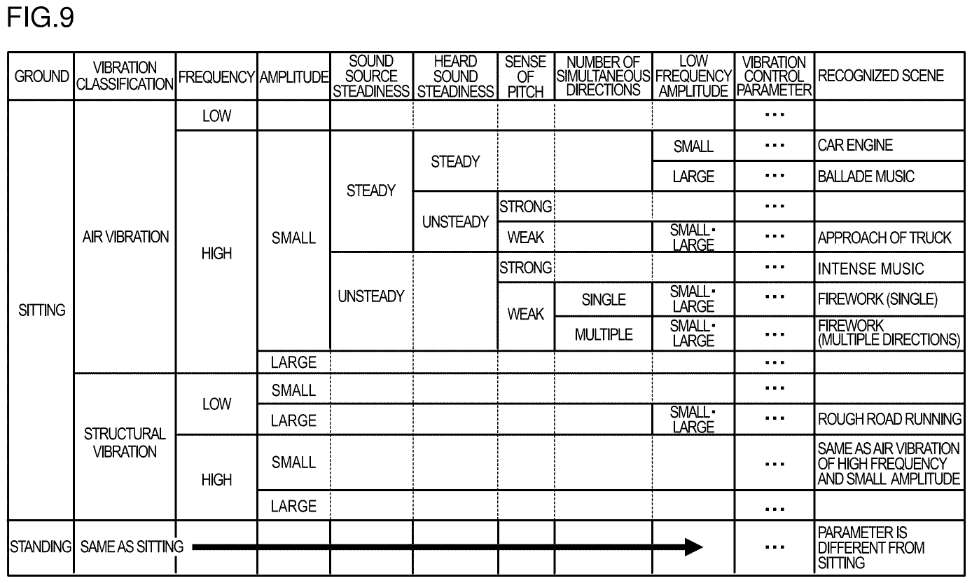

In addition, as illustrated in FIG. 9, the scene recognition DB 125 of the content reproduction device 10 stores various types of acoustic characteristics of the scene, classification of vibration, the grounded condition of the user in the content, and the vibration control parameter value, in association with the scene type. Note that data of the scene recognition DB 125 is, for example, created by the design developer or the like of the content reproduction device 10, based on an experiment or the like, and is stored in the scene recognition DB 125.

Note that as necessary (e.g., in accordance with a constitution of the user watching the content, or a ground environment of the content reproduction device 10), the user watching the content manually adjusts the charge of each vibration output unit 30 or the vibration control parameter value (Step S13).

In the stage when reproducing the content in Step S12, the controller 13 (a scene recognition section 135) of the content reproduction device 10 determines which scene stored in the scene recognition DB 125 is the scene of the currently playing content, based on acoustic characteristics and video characteristics of the scene of the currently playing content. In other words, the controller 13 (the scene recognition section 135) verifies characteristic data of the scene recognition DB 125 with acoustic characteristics or video characteristics of the scene of the currently playing content, so as to detect the scene of the data record in the scene recognition DB 125 that has the same characteristics.

Further, the controller 13 (the output section 134) reads the vibration control parameter value corresponding to the determined (detected) scene (the vibration control parameter value of the same data record in the scene recognition DB 125). Note that if the currently playing content has a plurality of scenes in which a vibration should be generated, the controller 13 (the priority order setting section 132) selects a scene having the highest priority as the scene in which a vibration should be generated. Further, based on the read vibration control parameter value and sound information of the currently playing content, the controller 13 (the output section 134) generates the vibration control signal for each vibration output unit 30 and outputs the same to each vibration output unit 30.

In other words, based on the vibration control parameter value for each vibration output unit 30, the controller 13 generates the vibration control signal of each vibration output unit 30 for each scene recognized from the content, so as to control the vibration generated by the each vibration output unit 30. Further, the vibration control parameter value is set based on the condition such as an installation status or the like of each vibration output unit 30 in the vibration seat P3 (vibration output mechanism). For this reason, the controller 13 generates the vibration control signal of each vibration output unit 30, based on the scene of the currently playing content, as well as a type of the vibration output unit 30, an installation location, and the number of units, so as to control the vibration generated by the vibration output unit 30.

In this way, it is possible to appropriately allow the vibration output units 30 to vibrate for various types of the vibration seats P3 (various types of the vibration output mechanisms), which have different types of the vibration output units 30, different installation locations, and different numbers of units. In addition, each vibration output unit 30 can be appropriately vibrated for various contents having different types and details, and the scenes thereof. In addition, as automatic setting of the vibration control parameter value for each vibration output unit 30 is realized by the controller 13, setting and adjustment of the vibration control parameter value accompanying change and alteration of the vibration seat P3 (the vibration output mechanism) can be efficiently performed.

In addition, the controller 13 sets the vibration control parameter value for each scene of the currently playing content, so as to control the vibration generated by the vibration output unit 30, based on the vibration control parameter value. For instance, if the content is a music video, the user can be provided with a vibration suitable for the music such as slow music like a ballade or other up-tempo music. In addition, for example, if the content is an animal documentary, the user can be provided with a vibration suitable for the scene such as an elephant's walking scene or a horse's running scene. In other words, a vibration suitable for the scene of the currently playing content is provided to the user, so that presence of content can be improved.

Note that it may be possible that the controller 13 sets the vibration control parameter value not for each scene of the currently playing content, but for each content in accordance with the content type (overall detail of the content), and allows each vibration output unit 30 to vibrate based on the vibration control parameter value. In this case, for example, if the content is a music video, it is possible to provide the user with a vibration that is suitable for allowing the user to listen to the music. In addition, for example, if the content is an animal documentary, it is possible to provide the user with a vibration that is suitable for allowing the user to observe animal biology or for explaining the same. In other words, a vibration suitable for details of the content is provided to the user, so that presence of content can be improved.

<4. Scene Recognition Process when Reproducing Content>

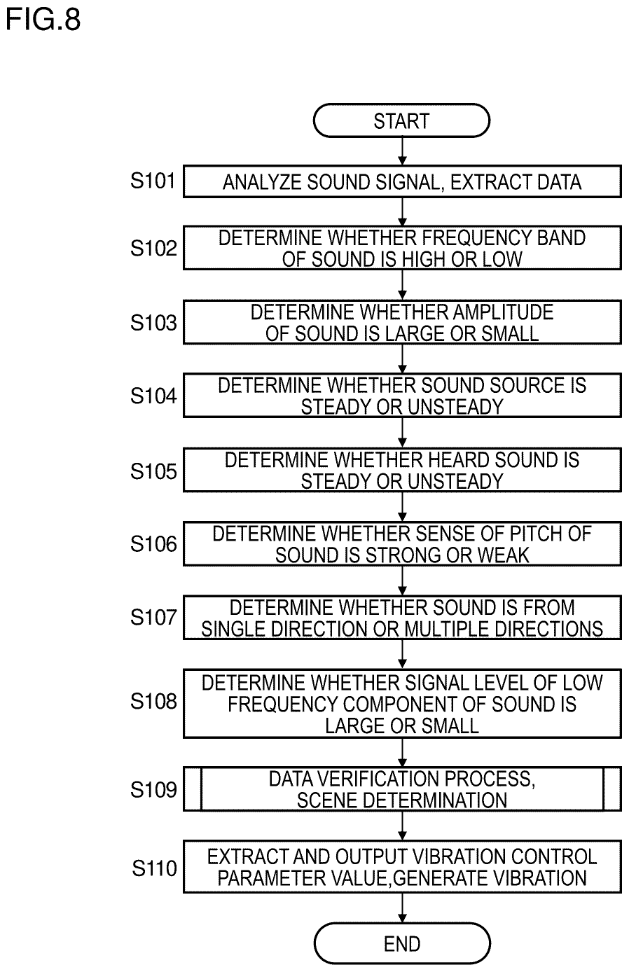

FIG. 8 is a flowchart illustrating a scene recognition process of the currently playing content performed by the controller 13 of the content reproduction device 10 of FIG. 3. Specifically, FIG. 8 is a flowchart illustrating the scene recognition process of determining an appropriate vibration classification of the vibration, which is generated for each scene of the currently playing content, performed by the controller 13 of the content reproduction device 10. This flowchart shows a technical detail of a computer program that allows the computer device to realize the scene recognition process. In addition, the computer program is provided (sold or distributed), for example, in a form of various types of readable nonvolatile recording medium storing the computer program, or a form of downloading from a server storing the computer program via a communication line. The computer program may be constituted of a single program or may be constituted of a plurality of programs that cooperate with each other.

This scene recognition is started in the content preparation stage before reproducing in S11, e.g., by a preparation start operation before reproducing the content performed by the user.

FIG. 9 is a diagram illustrating an example of the scene recognition DB 125. Specifically, FIG. 9 illustrates a database of information for determining the vibration classification (the air vibration or the structural vibration) and the vibration control parameter value of each scene, based on each item value based on a result of the scene recognition process of FIG. 8. The vibration classification data of a data record, in which each item value of FIG. 9 agrees with a result of the scene recognition process, is the vibration type of the generated vibration suitable for the scene, and the vibration control parameter value of the same is the vibration control parameter value of the generated vibration suitable for the scene. Note that it is also possible to perform setting corresponding to both vibration classification (the air vibration and the structural vibration) in the same scene, and in this case, the vibration is generated in accordance with the vibration control parameter value corresponding to each vibration output unit 30 that charges the air vibration charge or the structural vibration charge.

Note that the scene recognition DB 125 in this example is a database (data table) of sound in the content and a recognized scene corresponding to a sitting or standing status of the virtual character corresponding to the user watching the content. Note that, for easy understanding of a relationship between each item value and the vibration classification, columns or rows of data records, which have the same data of each item, are appropriately combined for each item. In addition, data of the standing status of the virtual character has the same data record form as the sitting status, and hence the whole details are not shown.

As illustrated in FIG. 9, the data items in the scene recognition DB 125 include “frequency”, “amplitude”, “sound source steadiness”, “heard sound steadiness”, “sense of pitch”, “number of simultaneous directions”, and “(heard sound) low frequency amplitude”, which are characteristics of sound (sound data) in the scene of the content, and “ground” item indicating the sitting or standing status of the virtual character corresponding to the watching user that can be determined from image data or the like of the content, and vibration classification of an appropriate generated vibration in a content status indicated by other item, which are associated with the recognized scene (stored in the data record created for each recognized scene). In addition, the data items of the scene recognition DB 125 also include “vibration control parameter”, for which the vibration control parameter value suitable for the scene of the data record is stored. As to each data of the scene recognition DB 125, the designer or the like of the content reproduction device 10 selects an appropriate scene based on an experiment or the like, and generates characteristic data of sound corresponding to the scene, the vibration control parameter value adaptable to the scene, and the like, which are stored.

Note that “vibration control parameter” may be another database, i.e., the parameter information DB 124 as illustrated in FIG. 5, and data records of the both databases may be associated with each other by the scene type (data of the items “recognized scene” and “scene type”).

Further, the scene recognition DB 125 also includes the item “recognized scene” indicating the scene type, and identification data (such as a scene name) of the scene type, which is the same as each item data related to characteristics of the sound (sound data) of the above content scene, is stored as the data of “recognized scene”.

The process illustrated in FIG. 8, which is a flowchart illustrating a vibration control process when reproducing the content, is repeatedly performed by the controller 13 while the content is being reproduced (at a period that an influence of delay of changing the vibration control parameter value, which accompanies a scene change, does not make the user watching the content feel uncomfortable).

In Step S101, the controller 13 (the scene recognition section 135) inputs and analyzes the sound signal of the scene of the currently playing content, extracts data about each item of characteristics of the sound, and proceeds to Step S102. Note that the sound signal analysis is realized by digitalizing the sound signal and by performing various types of process such as frequency decomposition by the arithmetic process. In addition, it may be possible to input and analyze the video signal of the scene of the currently playing content, and to use its result for determining characteristics of the sound as described below.

In Step S102, the controller 13 (the scene recognition section 135) determines whether a frequency band (main band) of the sound in the scene is high or low (determines based on a high or low relationship with a threshold value), and proceeds to Step S103. In other words, for example, the threshold value is determined to be a frequency of 20 Hz, and the scene recognition section 135 determines that the frequency is low if the sound intensity distribution lower than 20 Hz is high, while it determines that the frequency is high if the sound intensity distribution higher than 20 Hz is low.

In Step S103, the controller 13 (the scene recognition section 135) determines whether an amplitude of the sound (average value or maximum value) is large or small (determines based on a high or low relationship with a threshold value), and proceeds to Step S104.

In Step S104, the controller 13 (the scene recognition section 135) determines whether the sound source is steady or unsteady (whether it generates steady sound or sudden sound), and proceeds Step S105. The sound source means an object that generates sound in the content. A sound source generating continuous similar sound such as car's running sound or animal's footstep is steady, while a sound source generating sudden sound such as car's horn sound or an animal's cry is unsteady. As an example of the determination method, for example, the scene recognition section 135 determines that the sound source is steady if a dynamic range of the sound from the sound source is lower than a predetermined threshold value determined in advance, while it determines that the sound source is unsteady if the same is higher than the threshold value.

In Step S105, the controller 13 (the scene recognition section 135) determines whether the heard sound is steady or unsteady, and proceeds to Step S106. The heard sound means sound heard by the user (the avatar corresponding to the user) in the content (e.g., the XR content space), i.e., the sound captured by the microphone of the user in the content. For instance, the scene recognition section 135 determines that the sound source is steady if the dynamic range of the heard sound is lower than a predetermined threshold value determined in advance, while it determines that the sound source is unsteady if the same is higher than the threshold value.

In Step S106, the controller 13 (the scene recognition section 135) determines whether sense of pitch of the sound is strong or weak, and proceeds to Step S107. For instance, the scene recognition section 135 determines that the sense of pitch is high if a high/low fluctuation of the sound (frequency fluctuation) is large (such as an animal's cry having a large fluctuation of pitch of sound having a wide frequency range), while it determines that the sense of pitch is low if the same is small (such as steady sound of a machine having a narrow frequency range).

In Step S107, the controller 13 (the scene recognition section 135) determines whether the sound is generated from a single direction or from multiple directions, and proceeds to Step S108. For instance, the scene recognition section 135 determines that the sound is generated simultaneously from multiple directions if there are a plurality of sound sources at distances closer to the user than a predetermined threshold value determined in advance, and otherwise it determines that the sound is generated from a single direction.

In Step S108, the controller 13 (the scene recognition section 135) determines whether a signal level of a low frequency component of the sound is large or small, and proceeds to Step S109. For instance, the scene recognition section 135 determines that the low frequency component of the sound is large, if a sound pressure of a sound component having a frequency that is a predetermined frequency determined in advance or lower is higher than a predetermined threshold value determined in advance, while it determines that the low frequency component of the sound is small if the same is lower than the threshold value.

In Step S109, the controller 13 (the scene recognition section 135) performs a data verification process of the scene recognition DB 125 using the determination results in Steps S101 to S108 so as to determine the corresponding scene, and proceeds to Step S110.

In Step S110, the controller 13 (the output section 134) extracts the vibration control parameter value corresponding to each vibration output unit 30 according to the scene determined from the scene recognition DB 125, and processes the sound signal of the content using the vibration control parameter value so as to generate vibration signal. Further, the generated vibration signal is output to each corresponding vibration output unit 30 so that a desired vibration is generated, and the process is finished. Note that the controller 13 (the output section 134) continues to generate the vibration according to detail (sound) of the currently playing content until the vibration control parameter value is updated, using the vibration control parameter value before the update.

According to the process of FIG. 8, in accordance with a hardware configuration of the content reproduction system PS and sound characteristics during reproduction of the content, the vibration control parameter value suitable for each vibration output unit 30 of the content reproduction system PS is set, and each vibration output unit 30 vibrates in accordance with the vibration generated based on the set vibration control parameter value. Therefore, an appropriate vibration according to the hardware configuration of the content reproduction system PS and detail of the content can be provided to the user watching the content, so that the user watching the content can enjoy reproduction of the content having rich presence.

Note that in this example of the process, the vibration control parameter value is determined (calculated) when reproducing the content, but it may be possible to calculate the vibration control parameter value of the content to be produced in advance, using the same method, and to store the same in association with a reproduction scene of the content (such as reproduction time or scene). Then, it may be possible to extract the vibration control parameter value associated with the corresponding scene when reproducing the content, so as to perform the vibration control. In this case, the vibration control parameter value should be recorded as one of content information, together with content main information (video and sound information), in a content recording medium such as a content optical disc.

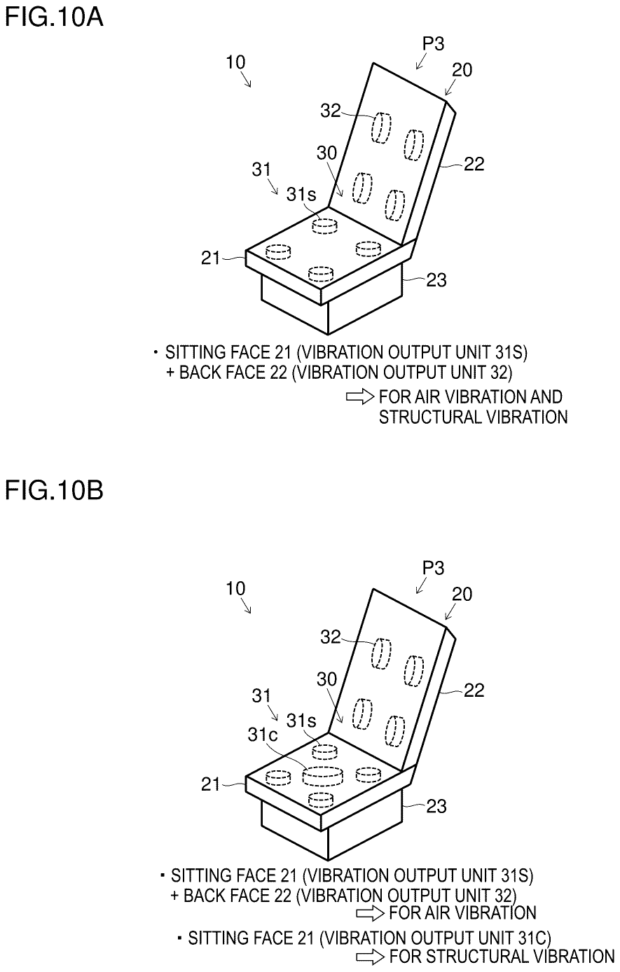

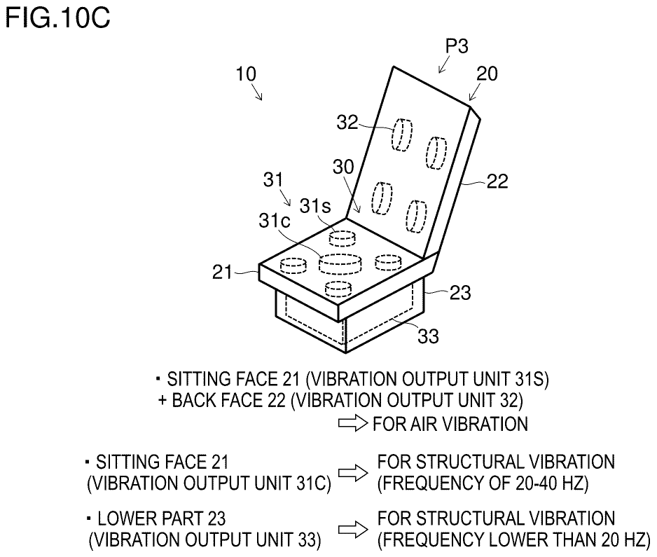

FIGS. 10A, 10B, and 10C are explanatory diagrams illustrating respectively a first example, a second example, and a third example of the charge (the structural vibration, the air vibration) of the vibration output units 30 in the content reproduction device 10 of FIG. 6. The charges of the vibration output units 30 are different depending on the hardware configuration of the content reproduction system PS and detail of the content (scene).

In this embodiment, in FIG. 10A, the vibration output units 31s in the four corners of the seating face 21 and the four vibration output units 32 on the back face 22 each charge the air vibration and the structural vibration. In FIG. 10B, the vibration output units 31s in the four corners of the seating face 21 and the four vibration output units 32 on the back face 22 charge the air vibration, and the vibration output unit 31c in the center of the seating face 21 charges the structural vibration. In FIG. 10C, the vibration output units 31s in the four corners of the seating face 21 and the four vibration output units 32 on the back face 22 charge the air vibration, the vibration output unit 31c in the center of the seating face 21 charges the structural vibration (frequencies of 20 Hz to 40 Hz), and the vibration output unit 33 in the lower part 23 of the seat 20 charges the structural vibration (frequencies lower than 20 Hz). In other words, the content reproduction device 10 generates and outputs the vibration signals of the vibration output units 30, 31, and 32 in accordance with the vibration control parameter value (set in the scene recognition DB 125), according to roles of the vibration output units 30, 31, and 32, so as to generate the structural vibration or the air vibration.

### 5. Modified Example

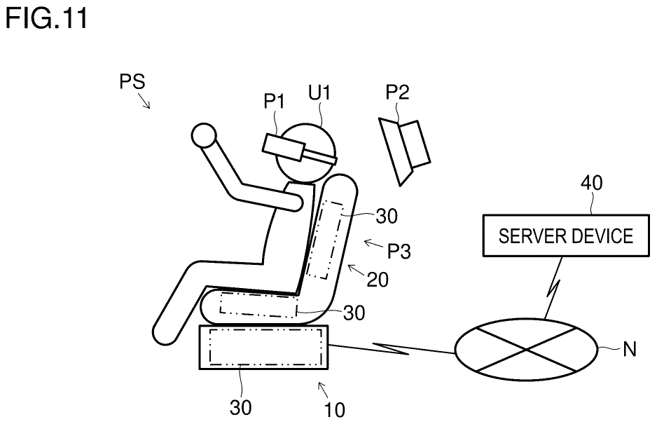

FIG. 11 is an explanatory diagram illustrating an example of the content reproduction system PS of a modified example. Note that in the modified example, the same structural element as in the embodiment described above may be denoted by the same numeral or symbol or the same name, and description thereof may be omitted.

As illustrated in FIG. 11, the content reproduction system PS of the modified example is connected to a server device 40 using a communication line.

The content reproduction device 10 has the same structural element as in the embodiment described above. The content reproduction device 10 outputs to the vibration output unit 30 the vibration signal according to the content to be reproduced, and the vibration output unit 30 provides a vibration to the user U1.

The server device 40 is connected to the content reproduction device 10 via a network N in a bidirectionally communicable manner. The server device 40 may be a physical server or may be a virtual server. The network N is, for example, a local area network, the Internet, or the like.

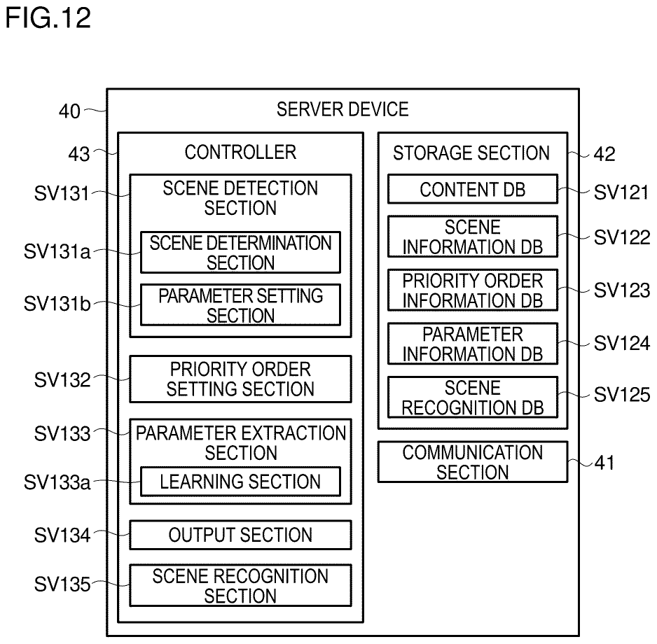

FIG. 12 is a structural diagram illustrating an example of the server device 40 of FIG. 11. In FIG. 12, structural elements necessary for describing features of this embodiment are shown, and ordinary structural elements are not shown.

As illustrated in FIG. 12, the server device 40 includes a communication section 41, a storage section 42, and a controller 43. The communication section 41 is an interface for performing data communication with other devices via the network N. The communication section 41 is a network interface card (NIC), for example.

Note that the server device 40 includes the same structural element as the content reproduction device 10 of the embodiment described above. Note that the same structural element (having the same structure, operation, and the like) is referred to by the same name as the structural element in FIG. 3, and is denoted by the same numeral or symbol plus a prefix of SV, and the description thereof is omitted.

In the content reproduction system PS of this modified example, the content reproduction device 10 sends to the server device 40 hardware configuration information of the content reproduction device 10, video information indicating the sitting status of the user U1 watching the content in the vibration seat P3, and information of the content to be reproduced. In addition, the server device 40 sends to the content reproduction device 10 the vibration control signal of each vibration output unit 30 of the vibration seat P3. Further, the content reproduction device 10 synchronizes the content image signal and sound signal with the vibration control signal from the server device 40, which are output to the display device P1, the speaker P2, and each vibration output unit 30.

Note that role sharing between the content reproduction device 10 and the server device 40 can be appropriately set without limiting to the modified example. For instance, it may be possible to allow the server to have also a content reproduction function, and to send from the server device 40 to the content reproduction device 10 the content video signal and sound signal, and the vibration control signal of each vibration output unit 30.

By using the server device 40, it is possible to allow the server device 40 to have information and programs that can support various types of the content reproduction systems PS having different configurations, and to perform the process corresponding to the hardware configuration of the content reproduction system PS and the content to be reproduced, responding to a request from the content reproduction system PS. Therefore, this modified example can obtain effects that the content reproduction systems PS are not required to have a dedicated configuration separately, and that the server device 40 can perform management for updating the various types of information and programs.

### <6. Designing Process of Vibration Seat (Vibration Output Mechanism) of Content Reproduction System>

Next, the designing process of the vibration output mechanism is described with an example of the designing process of the vibration seat P3 of the content reproduction system PS.

This example of the designing process describes a case where the server device 40 is used as a design assistance device for the vibration output mechanism, but it is also possible to use the content reproduction device 10. In addition, this designing process can be realized also in a designing system or the like using a computer system, which has the same structural element as in the server device 40 used for the process in the following description.

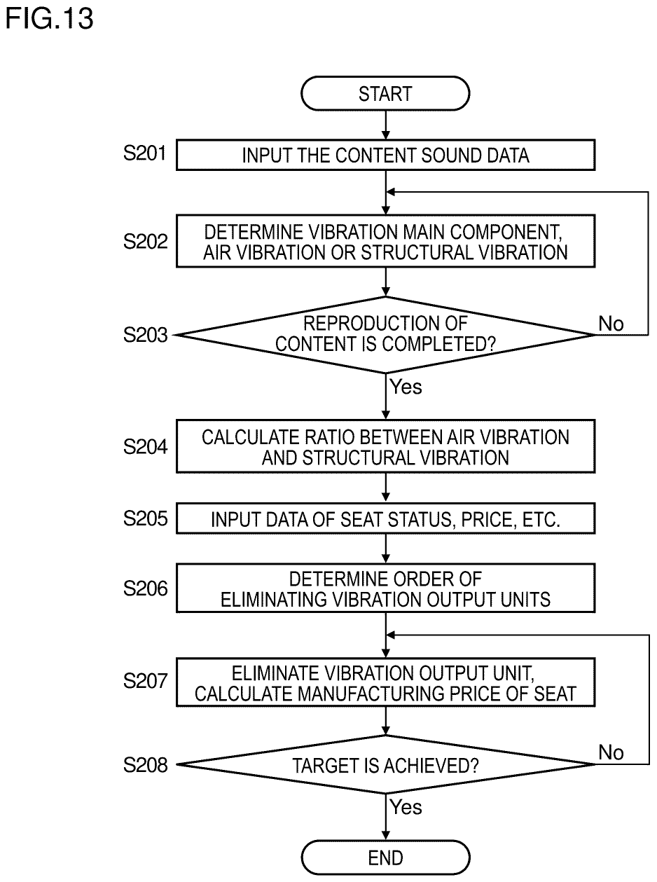

FIG. 13 is a flowchart illustrating a designing process of the vibration seat P3 performed by the controller 43 of the server device 40 of FIG. 12. This flowchart illustrates a technical detail of a computer program that allows the server device 40 to realize the designing process of the content reproduction device 10. In addition, for example, the computer program is provided (sold or distributed), for example, in a form of various types of readable nonvolatile recording medium storing the computer program, or a form of downloading from a server storing the computer program via a communication line. The computer program may be constituted of a single program or may be constituted of a plurality of programs that cooperate with each other.

The process illustrated in FIG. 13 is performed in the server device 40, when the designer of the content reproduction device 10 performs the designing process, e.g., when a process start operation is performed by an operation section such as a keyboard.

In Step S201, the controller 43 inputs the content sound data, and proceeds to Step S202. In this case, the content video data may also be input for use in a determination process or the like afterward. Note that as the content to be used, if content having high frequency of use in the content reproduction system PS or a similar type of content is used, it is possible to perform designing suitable for the content having high frequency of use. For instance, if the content reproduction system PS dedicated to a certain game is designed, the game content is used.

In Step S202, the controller 43 (a scene detection section SV131) determines which one of the air vibration and the structural vibration is the main component of the vibration to be generated, based on the content sound data, and by referring to the video data if necessary, and stores a result of the determination in the storage section 12, and proceeds to Step S203.

In Step S203, the controller 43 (the scene detection section SV131) determines whether or not the reproduction of the content is completed (a preset quantity necessary for designing). If the reproduction is not completed, the process returns to Step S202, while if it is completed, the process proceeds to Step S204. In other words, based on the process of Steps S202 and S203, the quantity of status in which the main component of the vibration to be generated in the target content is the air vibration, and the quantity of status in which the same is the structural vibration can be grasped.

In Step S204, the controller 43 (the scene detection section SV131) calculates a ratio between the vibration status in which the air vibration is the main component in the target content, and the vibration status in which the structural vibration is the main component, and proceeds to Step S205.

In Step S205, the controller 43 inputs data of a status of the seat in which all the installable vibration output units 30 are installed in the vibration seat P3 (a position and a vibration effect level of each vibration output unit 30), and inputs data of parts price and installation cost of each vibration output unit 30, and a target price or the like of the vibration seat P3 to be designed, and proceeds to Step S206. Note that these information of the vibration seat P3 are input by the designer or the like of the vibration seat P3, who operates the keyboard or the like, for example.

In Step S206, based on the ratio between the air vibration and the structural vibration in the target content calculated in Step S204 and the vibration effect level of each vibration output unit 30 (contribution to improvement of presence) input in Step S205, the controller 43 determines an order of eliminating the vibration output units 30, and proceeds to Step S207. In other words, as the vibration generation ratio of the vibration type (the air vibration, the structural vibration) charged in the target content is lower, and as the vibration effect to the user watching the content is lower, the order of being eliminated is faster (the priority order of being eliminated is higher).

For instance, it is supposed that a vibration component ratio as a ratio of each main component between the air vibration and the structural vibration in the target content is 8:3, and that the vibration output units that charge the air vibration charge are units A1, A2, and A3 in order of higher vibration effect level, and that the vibration output units that charge the structural vibration are units B1, B2, and B3 in order of higher vibration effect level. Because a ratio of the air vibration is large in the target content, the first priority order of being eliminated is the vibration output unit B3, which has the lowest vibration effect level among the vibration output units that charge the structural vibration. Further, because the one priority order of being eliminated of the vibration output unit that charges the structural vibration is determined, in order to lower a domination ratio of the air vibration, the ratio of the air vibration is reduced (e.g., reduced to a half)(the vibration component ratio becomes 4:3). Continuing the same process, because the ratio of the air vibration is large the next time too, the second priority order of being eliminated is the vibration output unit B2, which has the lowest vibration effect level among the vibration output units that charge the structural vibration. Then, the new vibration component ratio becomes 2:3. Next, because the ratio of the structural vibration is large, the third priority order of being eliminated is the vibration output unit A3, which has the lowest vibration effect level among the vibration output units that charge the air vibration. Further, this process is continued until all the priority orders of being eliminated are determined. In this case, the priority orders of being eliminated are vibration output units B3, B2, A3, B1, A2, and A1 from the highest priority.

Note that the vibration effect level is determined, for example, by a statistical process on results of sensory evaluation of design development group members, e.g., evaluation of the vibration effect level by subjects, when a certain content is reproduced and a plurality of the vibration output units 30 are sequentially set in the vibration generation state (such as questionnaire results from the subjects).

In Step S207, the controller 43 eliminates the vibration output unit 30 determined in Step S206 as having the highest priority order of being eliminated, among the vibration output units 30 mounted in the vibration seat P3, and calculates a manufacturing price of the vibration seat P3 in this case, based on the input prices or the like of the vibration output units 30 of the vibration seat P3, and proceeds to Step S208. Note that in this example, the vibration output unit 30 is eliminated simply in accordance with the priority order of being eliminated of the vibration output unit 30, but it may be possible to eliminate by taking a factor such as cost of the vibration output unit 30 or a residual value toward goal achievement, which will be described later, into consideration.

In addition, this elimination of members of the vibration seat P3 is a virtual process for calculating a manufacturing price, and the members of the vibration seat P3 (a real body) are not really eliminated. In reality, the designer or the like will determine the final specification and design, with reference to the result after the above evaluation process is finished, for example.

In Step S208, the controller 43 determines whether or not a predetermined target cost and a predetermined target quantity of the vibration output units 30 are achieved for the vibration seat P3 (whether or not the target or less is satisfied), and if the target is achieved, the result (the configuration of the vibration seat P3 in which the vibration output units 30 are appropriately eliminated) is informed (displayed) to finish the process, while if the target is not achieved, the process returns to Step S207, so as to continue the elimination process and the evaluation process.

In this way, while performing the simulation eliminating the vibration output units 30 mounted in the vibration seat P3 in the appropriate order, the configuration of the vibration seat P3 that satisfies the target can be checked, and hence efficient design of the content reproduction system PS (the vibration seat P3) can be achieved.

### <7. Consideration>

The various technical features disclosed as the embodiment in this specification can be variously modified within the scope of the technical creation without deviating from the spirit thereof. In other words, the above embodiment is merely an example and is not a limitation. The technical scope of the present invention is defined not by the above description of the embodiment but by the claims, which include all modifications within meaning and scope equivalent to the claims. In addition, the plurality of embodiments disclosed in this specification can be appropriately combined and implemented within the possible range.

In addition, the above embodiment describes that various types of functions are realized by software with the arithmetic process of the CPU according to the program, but at least a part of these functions may be realized by electrical hardware resources. The hardware resources may be an application specific integrated circuit (ASIC), a field programmable gate array (FPGA), and the like, for example. On the contrary, at least a part of the functions that are described as being realized by hardware resources may be realized by software.

In addition, the scope of this embodiment may include a computer program that allows a processor (computer) to realize at least a part of the functions of the content reproduction device 10. In addition, the scope of this embodiment may include a nonvolatile recording medium that stores the above computer program and can be read by a computer. The nonvolatile recording medium may be, in addition to the above nonvolatile memory, an optical recording medium (such as an optical disc), a magneto-optical recording medium (such as a magneto-optical disk), a USB memory, an SD card, or the like, for example.

### LIST OF REFERENCE SIGNS

10 content reproduction device
12 storage section
13 controller
20 seat
21 seating face
22 back face
23 lower part
30, 31, 31c, 31s, 32, 33 vibration output unit
40 server device (design assistance device)
P1 display device
P2 speaker
P3 vibration seat (vibration output mechanism)
PS content reproduction system
U1 user

1-11. (canceled)

12. A vibration signal generation device configured to generate a vibration signal according to content, the device comprising a controller, wherein the controller is configured to:
obtain a sound signal of the content;
detect a plurality of vibration output units disposed in a vibration output mechanism;
obtain at least one parameter value for each of the vibration output units; and
generate the vibration signal for each of the vibration output units, based on sound signal and the parameter value for each of the vibration output units.

13. The vibration signal generation device according to claim 12, further comprising a memory configured to store the parameter value for each of the vibration output units, wherein the controller is configured to obtain the parameter value corresponding to each vibration output unit from the memory.

14. The vibration signal generation device according to claim 13, wherein
the memory stores the parameter value corresponding to a scene of the content, and
the controller is configured to detect the scene of the currently playing content, and obtain the parameter value corresponding to the scene and the vibration output unit from the memory.

15. The vibration signal generation device according to claim 12, wherein the controller is further configured to:
separate the sound signal into a sound signal for air vibration and a sound signal for structural vibration;
generate an air vibration signal based on the sound signal for air vibration and the parameter value corresponding to the air vibration; and
generate a structural vibration signal based on the sound signal for structural vibration and the parameter value corresponding to the structural vibration.

16. The vibration signal generation device according to claim 12, wherein the parameter value is selected from the group consisting of:
a cutoff frequency of a low-pass filter that extracts a low-frequency component from the sound signal;
a delay time that delays the sound signal; and
an amplification factor for the sound signal.

17. A content reproduction system comprising:
a video display unit configured to display video according to a video signal;
a sound output unit configured to output sound according to a sound signal;
a vibration output mechanism configured to output a vibration according to a vibration signal; and
a content reproduction device configured to output the video signal, the sound signal, and the vibration signal according to a content, to the video display unit, the sound output unit, and the vibration output mechanism, wherein
the content reproduction device includes a controller, and the controller is configured to:
obtain the sound signal of the content;
detect a plurality of vibration output units disposed in the vibration output mechanism;
obtain a parameter value for each of the vibration output units; and
generate the vibration signal for each of the vibration output units, based on the sound signal and the parameter value for each of the vibration output units.

18. The content reproduction system according to claim 17, wherein
the content reproduction device includes a memory configured to store the parameter value for each of the vibration output units, and
the controller is configured to obtain the parameter value corresponding to each vibration output unit from the memory.

19. The content reproduction system according to claim 18, wherein
the memory stores the parameter value corresponding to a scene of the content, and
the controller is configured to detect the scene of the currently playing content, and obtain the parameter value corresponding to the scene and the vibration output unit from the memory.

20. The content reproduction system according to claim 17, wherein the controller is further configured to:
separate the sound signal into a sound signal for air vibration and a sound signal for structural vibration;
generate an air vibration signal based on the sound signal for air vibration and the parameter value corresponding to the air vibration; and
generate a structural vibration signal based on the sound signal for structural vibration and the parameter value corresponding to the structural vibration.

21. The content reproduction system according to claim 17, wherein the parameter value is selected from the group consisting of:
a cutoff frequency of a low-pass filter that extracts a low-frequency component from the sound signal;
a delay time that delays the sound signal; and
an amplification factor for the sound signal.

22. A method for generating a vibration signal according to content, performed by a controller, the method comprising:
obtain a sound signal of the content;
detect a plurality of vibration output units disposed in a vibration output mechanism;
obtain at least one parameter value for each of the vibration output units; and
generate the vibration signal for each of the vibration output units, based on the sound signal and the parameter value for each of the vibration output units.

23. The method for generating a vibration signal according to claim 22, further comprising:
storing the parameter value for each of the vibration output units in a memory; and
obtaining the parameter value corresponding to each vibration output unit from the memory.

24. The method for generating a vibration signal according to claim 23, further comprising:
storing the parameter value corresponding to a scene of the content in the memory;
detecting the scene of the currently playing content; and
obtaining the parameter value corresponding to the scene and the vibration output unit from the memory.

25. The method for generating a vibration signal according to claim 22, further comprising:
separating the sound signal into a sound signal for air vibration and a sound signal for structural vibration;
generating an air vibration signal based on the sound signal for air vibration and the parameter value corresponding to the air vibration; and
generating a structural vibration signal based on the sound signal for structural vibration and the parameter value corresponding to the structural vibration.

26. The method for generating a vibration signal according to claim 22, wherein the parameter value is selected from the group consisting of:
a cutoff frequency of a low-pass filter that extracts a low-frequency component from the sound signal;
a delay time that delays the sound signal; and
an amplification factor for the sound signal.
